(19) United States
(12) Patent Application Publication
(10) Pub. No.: US 2012/0161924 A1
(43) Pub. Date: Jun. 28, 2012

(54) Automatic Authentication of Electronic Devices

(75) Inventor: Chang-Ming Lin, San Jose, CA (US)

(73) Assignee: RFMarq, Inc., Monte Sereno, CA (US)

(21) Appl. No.: 13/088,395

(22) Filed: Apr. 17, 2011

Related U.S. Application Data
(60) Provisional application No. 61/426,512, filed on Dec. 22, 2010.

(51) Int. Cl. G05B 19/00

(52) U.S. Cl. 340/5.8

(57) ABSTRACT

An electronic device with an embedded wireless tag may be authenticated by a linking partner, which may be another electronic device or a data network, before network connection can be established. In some embodiments, the electronic device includes an embedded wireless communicator for communicating with the wireless tag through a wireless link to retrieve identification data for authentication. In other embodiments, the electronic device cooperates with an external wireless communicator to retrieve stored identification data from the embedded wireless tag. In alternate embodiments, an electronic device may authenticate a peripheral device with an embedded wireless tag before connection can be established with the peripheral device. The electronic device may further erase the data stored on the peripheral device when authentication fails.

### CROSS-REFERENCE TO RELATED APPLICATION

This application claims the benefit of U.S. Provisional Patent Application Ser. No. 61/426,512, filed on Dec. 22, 2010, which application is incorporated herein by reference in its entirety.

### FIELD OF THE INVENTION

The invention relates to providing security protection for data communication systems and electronic devices, and, in particular, to systems and methods for providing automatic authentication of electronic devices in communication with a data communication network using an embedded wireless communication device or a wireless tag.

### DESCRIPTION OF THE RELATED ART

An important concern relating to modern day data communication networks is the security of the data traffic. Issues relating to network security include preventing unauthorized access to a network by unauthorized computing devices and use of misappropriated or stolen computer equipment to access a network. The increasing use of the data communication networks in all aspects of businesses and government operations demands heightened security protection.

Consumer electronic products can be tagged using electronic tracking devices or electronic tags to store product identity or other product information to allow the products to be tracked through the manufacturing process or through the supply and distribution chain and the rest of the product life. Electronic tags are read wirelessly by electronic readers (communicators) when the tags are within the communication range.

Radio frequency identification device (RFID) is an electronic tracking device commonly employed to track products and their movements. An RFID tag includes a wireless transceiver device, a memory and an antenna to enable radio frequency (RF) communication between the RFID tag and an RFID reader when the reader is brought within a communication range of the tag. The RFID transceiver device includes storage elements for storing identity or product information, and a circuit to receive incoming signals, generate response signals and transmit the response signals.

### SUMMARY OF THE INVENTION

According to one embodiment of the present invention, a method in an electronic device to authenticate the electronic device upon connection to a linking partner where the electronic device includes one or more integrated circuits and at least one of the one or more integrated circuit chip is a first processor includes embedding a wireless communication device with one of the one or more integrated circuits where the wireless communication device includes a first antenna, a first wireless transceiver and a memory circuit having at least identification data stored thereon and the first wireless transceiver and the first antenna operate in conjunction to enable the information stored in the memory circuit to be accessed through wireless communication; receiving an authentication request from the linking partner; initiating communication with a wireless communicator where the wireless communicator includes a second antenna, a second wireless transceiver and a second processor and the second wireless transceiver and the second antenna operate in response to instructions from the second processor to establish wireless communication with the wireless communication device to retrieve stored identification data; receiving retrieved identification data from the wireless communicator; transmitting the retrieved identification data to the linking partner for authentication; when the retrieved identification data is authenticated, establishing connection with the linking partner; and when the retrieved identification data is not authenticated, terminating connection with the linking partner.

According to another embodiment of the present invention, an electronic device including one or more integrated circuits where at least one of the one or more integrated circuit chip is a first processor includes a wireless communication device embedded with one of the one or more integrated circuits where the wireless communication device includes a first antenna, a first wireless transceiver and a memory circuit having at least identification data stored thereon and the first wireless transceiver and the first antenna operate in conjunction to enable the information stored in the memory circuit to be accessed through wireless communication; and a wireless communicator formed embedded in the electronic device where the wireless communicator includes a second antenna, a second wireless transceiver and a second processor and the second wireless transceiver and the second antenna operate in response to instructions from the second processor to establish wireless communication with the wireless communication device to retrieve stored identification data. The wireless communicator operates in response to the first processor of the electronic device to retrieve stored identification data from the wireless communication device and to provide the retrieved identification data to the first processor.

According to another embodiment of the present invention, an electronic device including one or more integrated circuits where at least one of the one or more integrated circuit chip is a first processor includes a dual-port wireless communication device embedded with one of the one or more integrated circuits. The wireless communication device includes a first antenna, a first wireless transceiver, a memory circuit having at least identification data stored thereon, and a wired communication port. The first wireless transceiver and the first antenna operate in conjunction to enable the information stored in the memory circuit to be accessed through wireless communication. The wired communication port operates to enable the information stored in the memory circuit to be accessed through wired communication. The first processor initiates instructions to the dual-port wireless communication device through the wired communication port to retrieve stored identification data from the wireless communication device and to provide the retrieved identification data to the first processor.

According to another embodiment of the present invention, a method in an electronic device to authenticate the electronic device upon connection to a linking partner where the electronic device includes one or more integrated circuits and at least one of the one or more integrated circuit chip is a first processor includes embedding a dual-port wireless communication device with one of the one or more integrated circuits where the wireless communication device includes a first antenna, a first wireless transceiver, a memory circuit having at least identification data stored thereon, and a wired communication port and the first wireless transceiver and the first antenna operate in conjunction to enable the information stored in the memory circuit to be accessed through wireless communication and the wired communication port operate to enable the information stored in the memory circuit to be accessed through wired communication; receiving an authentication request from the linking partner; initiating communication with the wireless communication device through the wired communication port; retrieving stored identification data from the wireless communication device; transmitting the retrieved identification data to the linking partner for authentication; when the retrieved identification data is authenticated, establishing connection with the linking partner; and when the retrieved identification data is not authenticated, terminating connection with the linking partner.

According to another embodiment of the present invention, a method in an electronic device to authenticate a peripheral device upon connection to the electronic device where the peripheral device includes one or more integrated circuits and having a wireless communication device embedded with one of the one or more integrated circuits of the peripheral device and the wireless communication device includes a first antenna, a first wireless transceiver and a memory circuit having at least identification data stored thereon where the first wireless transceiver and the first antenna operate in conjunction to enable the information stored in the memory circuit to be accessed through wireless communication, the method includes receiving a connection request from the peripheral device; initiating authentication of the peripheral device; initiating communication with a wireless communicator where the wireless communicator includes a second antenna, a second wireless transceiver and a second processor and the second wireless transceiver and the second antenna operate in response to instructions from the processor to establish wireless communication with the wireless communication device embedded in the peripheral device to retrieve stored identification data; receiving retrieved identification data from the wireless communicator; authenticating the retrieved identification data is authenticate; when the retrieved identification data is authenticated, establishing connection with the peripheral device; and when the retrieved identification data is not authenticated, terminating connection with the peripheral device.

The present invention is better understood upon consideration of the detailed description below and the accompanying drawings.

### BRIEF DESCRIPTION OF THE DRAWINGS

FIG. 1 is a schematic diagram of a wireless communication device according to one embodiment of the present invention.

FIG. 2 illustrates a functional block diagram of the wireless communication device of FIG. 1 according to one embodiment of the present invention.

FIG. 3 is a block diagram of a wireless communicator which can be used to communicate with the wireless communication device of FIG. 1 according to one embodiment of the present invention.

FIG. 4 is a block diagram of an electronic device with a wireless communication device and a wireless communicator embedded therein according to one embodiment of the present invention.

FIG. 5 illustrates a network environment in which the automatic authentication systems and methods of the present invention can be implemented according to one embodiment of the present invention.

FIG. 6 is a flow chart illustrating an automatic authentication method which can be implemented in the network environment of FIG. 5 according to one embodiment of the present invention.

FIG. 7 illustrates a network environment in which the automatic authentication systems and methods of the present invention can be implemented according to an alternate embodiment of the present invention.

FIG. 8 is a flow chart illustrating an automatic authentication method which can be implemented in the network environment of FIG. 7 according to one embodiment of the present invention.

FIG. 9 is a schematic diagram of a dual-port wireless communication device according to one embodiment of the present invention.

FIG. 10 is a block diagram of an electronic device with a dual-port wireless communication device embedded therein according to one embodiment of the present invention.

FIG. 11 is a flow chart illustrating an automatic authentication method which can be implemented in the network environment of FIG. 10 according to one embodiment of the present invention.

FIG. 12 illustrates a network environment in which the network security method can be implemented according to one embodiment of the present invention.

FIG. 13 is a flow chart illustrating a network security method according to one embodiment of the present invention.

FIG. 14 illustrates a computing environment in which the peripheral device security method can be implemented according to one embodiment of the present invention.

FIG. 15 is a flow chart illustrating a peripheral device security method according to one embodiment of the present invention.

FIG. 16 is a flow chart of an automatic authentication method according to an alternate embodiment of the present invention.

FIG. 17 and FIG. 18 illustrate the gloptop encapsulation methods for affixing a wireless tag to a semiconductor package according to embodiments of the present invention.

### DETAILED DESCRIPTION OF THE PREFERRED EMBODIMENTS

In accordance with the principles of the present invention, systems and methods implementing automatic authentication of an electronic device use identification data stored in a wireless communication device (“wireless tag”) embedded in the electronic devices. In some embodiments, an electronic device is embedded with a wireless tag storing identification data associated with the electronic device. When the electronic device attempts to connect to another electronic device or to a data communication network, the other electronic device or the data communication network authenticates the electronic device before allowing the network connection. The electronic device is authenticated by providing the identification data stored on the wireless tag to the linking partner. The stored identification data is retrieved through a communicator embedded in the electronic device or external to the electronic device. In this manner, secure access to a host electronic device or to a data communication network is realized.

The automatic authentication systems and methods of the present invention provide many advantages. The automatic authentication systems and methods can be applied to limit the hardware that can be connected to a secure computer network or to a secure computing device. In this manner security of a linking partner or a host computing device is ensured. The automatic authentication systems and methods are particularly useful in high security computer networks where access to the networks need to be strictly scrutinized to protect intrusion of the networks or invasion of highly sensitive data stored on the network. Furthermore, by embedding a wireless tag into an electronic device, the automatic authentication systems and methods of the present invention enable computer hardware to be tracked and identified whenever the hardware is connected to a computer network.

In the present description, an “electronic device” refers to a device constructed or implemented using integrated circuits or semiconductor devices and is capable of wired or wireless communication with at least another electronic device or another computing device. An electronic device may include one or more integrated circuits and the integrated circuits may be formed and interconnected on a printed circuit board (PCB). In embodiments of the present invention, electronic devices may include computing devices such as laptop computers, hand held computers, desktop computers, network computers and servers. Electronic devices may also include telecommunication devices such as mobile telephones, smartphones, mobile computing equipment, and telecommunication equipment. Electronic devices may also include personal digital assistant (PDA) devices, tablet computing devices or tablet computers such as the iPad from Apple, Inc., and other computing devices. Electronic devices may also include entertainment electronic devices such as video game consoles, televisions, eBook reader, and others.

In embodiments of the present invention, the electronic device is capable of wired or wireless communication with another electronic device, another computing device, or a data communication network. In the present description, a data communication network refers to a computer network formed by two or more interconnected computers. A data communication network (hereinafter “a data network”) includes hardware network elements connected thereto for transmitting and relaying messages to nodes (computers or computing devices) coupled to the network in accordance with a predefined network protocol. Hardware network elements include communication infrastructure devices, such as hubs, gateways, switches, bridges or routers. In embodiments of the present invention, a data network can be a local area network (LAN), a wide area network (WAN), or a wireless communication system. A data network can be a privately owned internet or intranet. The data network can also be the publicly accessible Internet that uses the standard Internet Protocol Suite (TCP/IP).

In the present description, an electronic device is described as being connected to a data communication network or to a data network. It is understood that a first electronic device may be connected to a second electronic device to form such a data communication network between the two electronic devices. Furthermore, a first electronic device may be connected to a second electronic device where the second electronic device is a server or a router or a gateway which is connected to a data network, such as a LAN, a WAN, or the publicly accessible Internet. Therefore, in the following description, an electronic device initiating a connection request to a data network refers to the network scenario where the electronic device initiates a connection request to another electronic device being a standalone system and the network scenario where the electronic device initiates a connection request to another electronic device being part of a larger data network.

In embodiments of the present invention, the data communication network may be part of a cloud computing system. In the present description, cloud computing refers to the provision of computational resources on demand via a computer network. Typically, cloud computing involves provisioning of dynamically scalable and often virtualized resources based on Internet protocols.

Wireless Communication Device (“Wireless Tag”)

Embodiments of the present invention employ a wireless communication device, also referred to as “a wireless tag,” embedded in an electronic device to store identification data for authentication purposes.

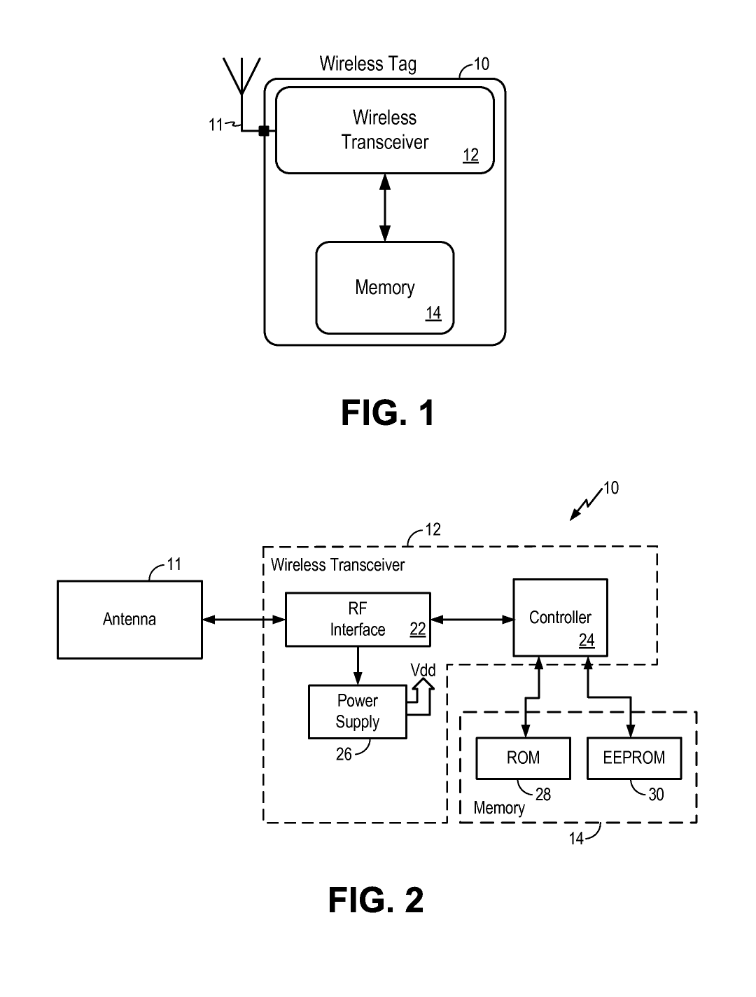

FIG. 1 is a schematic diagram of a wireless communication device according to one embodiment of the present invention. Referring to FIG. 1, a wireless communication device 10 (or “a wireless tag 10”) is preformed or manufactured as a standalone element for embedding into a semiconductor package of an integrated circuit. The wireless tag 10 includes a wireless transceiver 12, a memory 14 and an antenna 11. The wireless transceiver 12 and the memory 14, referred to collectively as a “wireless element,” are typically formed in a single integrated circuit die. In the present description, a “wireless element” refers to the combination of the wireless transceiver circuit and the memory circuit and may be formed in one or more integrated circuit die. The exact level of integration of the wireless transceiver and the memory of the wireless tag is not critical to the practice of the present invention. The antenna 11 is typically formed as a metallic antenna structure on or around the packaging of the wireless tag 10.

In embodiments of the present invention, the wireless communication device is capable of wireless communication employing one or more of the wireless communication technologies currently known or to be developed. For example, in one embodiment, the wireless communication device implements wireless communication through radio frequency (RF) communication, such as based on the RFID (radio frequency identification) technology. In another embodiment, the wireless communication device implements wireless communication based on the wireless local area network communication technology, such as Wi-Fi technology. In another embodiment, the wireless communication device employs Bluetooth radio technology. Bluetooth radio technology is an open specification for short-range wireless communication of data and voice that operates in the unlicensed Industrial, Scientific, Medical (ISM) band at 2.4 Gigahertz (GHz). The gross data rate may be 1 megabit per second (Mb/s). In yet another embodiment, the wireless communication device employs ZigBee communication technology. ZigBee is a wireless control technology utilizing a low-cost, low power, wireless mesh networking protocol that is especially useful in control and monitoring applications. In yet another embodiment, the wireless communication device employs WiMAX communication.

In the present embodiment, the wireless tag 10 is implemented as a radio frequency identification (RFID) tag. The wireless tag 10 can be implemented as a passive RFID tag or an active RFID tag. In a passive RFID tag, the wireless transceiver 12 and the memory 14 are powered by the energy received on the antenna 11 of the RFID tag. As an active RFID tag, the wireless tag 10 is powered by a battery power source or a power source from the electronic device in which the tag is embedded.

FIG. 2 illustrates a functional block diagram of the wireless communication device of FIG. 1 according to one embodiment of the present invention. Referring to FIG. 2, the wireless tag 10 includes an antenna 11 in communication with the wireless transceiver 12. The wireless transceiver 12 is in communication with the memory 14 for reading stored data from or writing data to be stored on the memory. The wireless transceiver 12 includes an RF interface 22 as the wireless communication interface. RF interface 22 operates in cooperation with antenna 11 to receive and transmit wireless signals. In the present embodiment, the wireless tag 10 is a passive RFID tag. Thus, RF interface 22 provides power from the received RF signal to a power supply 26 which generates a DC voltage Vdd to power the other components in the wireless tag. The wireless transceiver 12 further includes a controller 24 in communication with the RF interface 22 to receive and process incoming signals and to process and transmit outgoing signals. The controller 24 is also in communication with the memory 14 for reading data from and writing data to the memory 14. In the present embodiment, the memory 14 is implemented as a read-only memory (ROM) 28 and an electrical erasable programmable random access memory (EEPROM) 30.

In embodiments of the present invention, the wireless tag 10 stores in the memory 14 at least identification data of the electronic device or of integrated circuits forming the electronic devices in which the wireless tag is embedded. In other embodiments, the wireless tag may also store identification information of derivative system products incorporating the electronic device. In the present description, “identification data” of an electronic device includes the identification number, part number, model number, model name, brand name, maker, logo design, and production and/or distribution history of the electronic device. Furthermore, identification data can include a software code or an algorithm to generate an identity code in response to interrogations from a wireless reader or other systems. In embodiments of the present invention, the data format of the identification data includes a random or serial numerical numbers or characters, logo marks, graphic symbols, 2D graphic codes, or any multiplex permutation of these formats. Other encoding or algorithms methods currently known or to be developed can also be used. In an alternate embodiment, the identification data stored in the wireless tag is protected through the use of encryption or software keys or other feasible security protection methods presently known or to be developed.

According to embodiments of the present invention, the wireless tag 10 is embedded in an integrated circuit forming part of an electronic device. More specifically, in some embodiments, the wireless tag 10 is embedded into the semiconductor packages of the integrated circuit. In the present description, an “integrated circuit” refers to a semiconductor die or semiconductor chip housed or enclosed in a semiconductor package. An “integrated circuit” is sometimes referred to as an “integrated circuit chip” which is to be distinguished from a “semiconductor chip” which refers to the raw semiconductor die without packaging. An integrated circuit or an integrated circuit chip refers to a packaged semiconductor die.

Methods for embedding a wireless tag in a semiconductor package is described in U.S. Pat. No. 7,607,586 and also described in copending and commonly assigned U.S. patent application Ser. No. 13/005,336, filed Jan. 12, 2011, Ser. No. 13/018,860, filed Feb. 1, 2011, Ser. No. 12/977,042, filed Dec. 22, 2010, Ser. No. 12/977,045, filed Dec. 22, 2010, Ser. No. 12/977,049, filed Dec. 22, 2010, Ser. No. 12/977,050, filed Dec. 22, 2010. Methods for embedding a wireless tag in manufactured elements are described in U.S. Pat. No. 7,595,728. The aforementioned patents and patent applications are incorporated herein by reference in their entireties.

Wireless Communicator

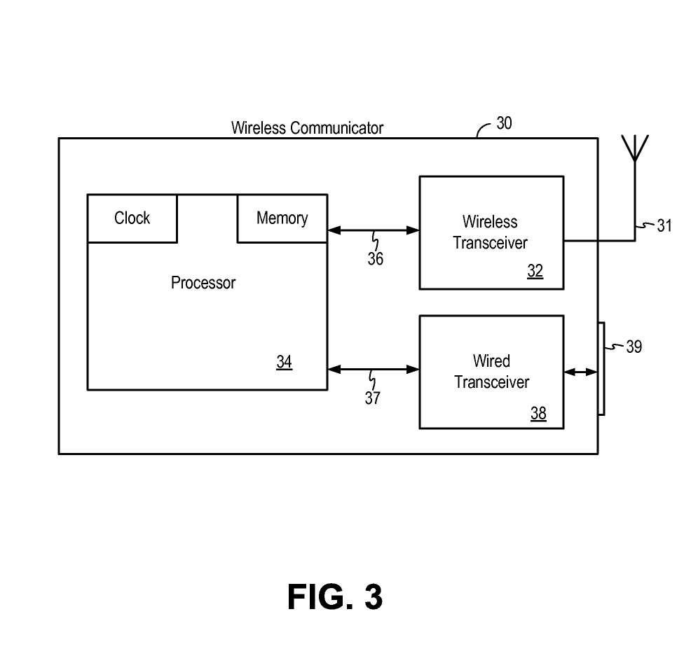

FIG. 3 is a block diagram of a wireless communicator which can be used to communicate with the wireless communication device of FIG. 1 according to one embodiment of the present invention. Referring to FIG. 3, a wireless communicator 30 includes an antenna 31 in communication with a wireless transceiver 32. Wireless transceiver 32 operates in cooperation with antenna 31 to receive and transmit wireless signals. In some embodiments, wireless communicator 30 may include a wired transceiver 38 coupled to a data port 39 for interfacing with a data cable or a data bus to receive and transmit signals over the data cable or data bus. In this manner, wireless communicator 30 is capable of supporting both wired and wireless communication. The use of wired transceiver 38 in wireless communicator 30 is optional and may be omitted when wired communication is not needed.

The wireless communicator 30 further includes a processor 34 in communication with the wireless transceiver 32 and the wired transceiver 38. The processor 34 controls the operation of the transceivers to transmit and receive data. The processor 34, may include memory circuitry and clock circuitry, controls the transfer of information to and from the wired and wireless transceivers 32 and 38. The processor 34 may implement a first communication protocol to control communication with the wired transceiver 38 and a second communication protocol to control communication with the wireless transceiver 32.

In operation, the processor 34 receives instructions from an external control circuit, such as an identification data request. In response, the processor 34 initiates wireless communication with a wireless tag it is associated with. In some embodiments, the processor 34 stores and executes program routines that issue commands to write to, read from and otherwise access the associated wireless tag. In some embodiment, the processor may implement a tag instruction set. In some embodiments, the tag instruction set includes at least the READ, WRITE, ERASE, QUIET, TALK, LOCK and KILL commands. The wireless communicator, under the control of an external controller, may write new data onto the wireless tag, may read stored data from the wireless tag, and perform other actions.

As thus configured, the wireless communicator 30 can be used to communicate with an associated wireless tag to retrieve stored identification data on the wireless tag. In embodiments of the present invention, the wireless communicator 30 may be implemented as one or more integrated circuits and may be embedded in an electronic device within communication range of a wireless tag. The wireless communicator 30 may also be implemented as a standalone device, such as a handheld device, to be placed within communication range of the wireless tag.

Electronic Device with Embedded Wireless Tag and Embedded Communicator

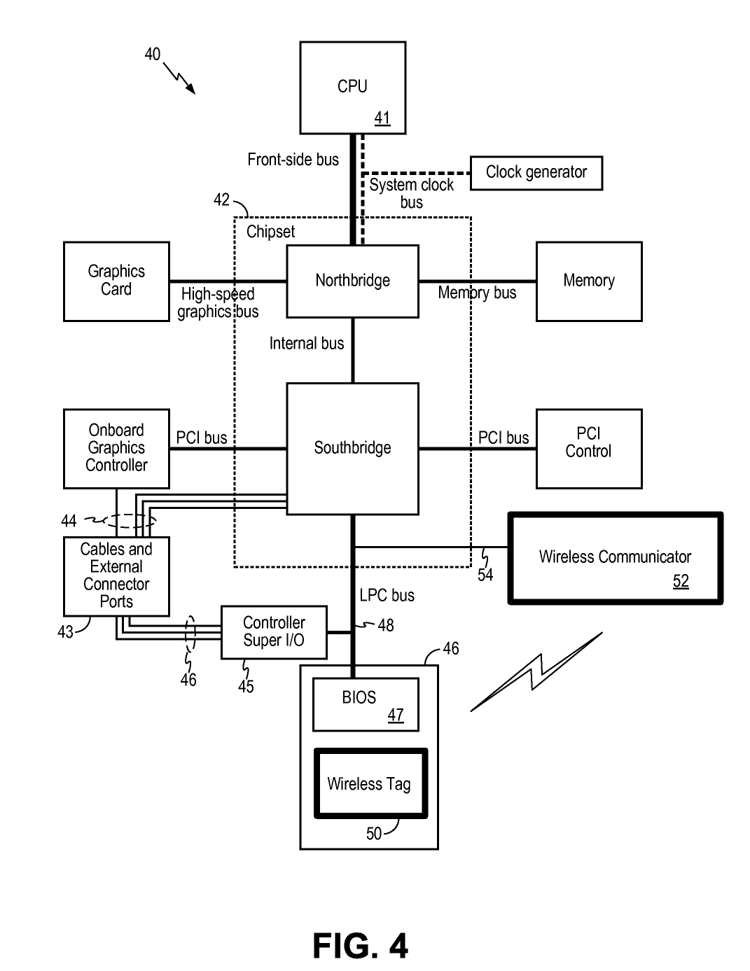

FIG. 4 is a block diagram of an electronic device with a wireless communication device and a wireless communicator embedded therein according to one embodiment of the present invention. When a wireless tag and a wireless communicator are thus embedded in the electronic device, the automatic authentication systems and methods of the present invention can be applied to automatically authenticate the electronic device when the electronic device is to be connected to a network, thereby ensuring network security.

Referring to FIG. 4, an electronic device 40 is a personal computer (PC) motherboard and includes components commonly associated with a PC motherboard. For instance, the PC motherboard 40 includes a central processing unit (CPU) 41, a logic chipset 42 including a Northbridge chip and a Southbridge chip. The PC motherboard 40 also includes a basic input/output system (BIOS) chip 46 and a controller super I/O chip 45. The PC motherboard 40 includes other logic blocks or logic chips, such as a graphics card, which are shown in FIG. 4 but will not be further described. The PC motherboard 40 also includes cables and external connector ports 43 for connecting to external device. The logic blocks for chips of the PC motherboard 40 are interconnected through various data buses, such as the front-side bus, the system clock bus and the PCI (Peripheral Component Interconnect) bus. A data bus 44 connects the Southbridge chip and the Onboard graphics controller chip to the external connector ports 43. A data bus 46 connects the controller super I/O chip 45 to the external connector ports 43. An LPC (Low Pin Count) bus 48 connects the BIOS chip 46 to the Southbridge chip.

In the present embodiment, a wireless tag 50 is embedded in the BIOS chip 46 of the PC motherboard 40. That is, the wireless tag 50 is formed within the packaging of the BIOS chip 46 so that the entire chip 46 appears as a monolithic semiconductor package but contains therein the BIOS semiconductor chip 47 as well as the wireless tag 50. Embedding the wireless tag 50 in the BIOS chip 46 is illustrative only and is not intended to be limiting. In other embodiments, the wireless tag 50 can be embedded into the semiconductor package of other integrated circuits on the motherboard 40, such as the Southbridge chip or Northbridge chip or the CPU chip. By embedding the wireless tag 50 in a semiconductor package in the electronic device 40, the wireless tag is protected against tampering.

In the present embodiment, a wireless communicator 52 is embedded in the PC motherboard 40. More specifically, the wireless communicator 52 is formed on the motherboard and is in communication with CPU 41 through a data bus 54. The wireless communicator 52 may be formed as one or more integrated circuits on the motherboard.

When the electronic device 40 is thus configured with the embedded wireless tag 50 and the embedded wireless communicator 52, the electronic device 40 can be operated to enable authentication of its identify using the automatic authentication systems and methods of the present invention, as will be described in more detail later. In brief, when the electronic device 40 receives an authentication request, the CPU 41 directs the wireless communicator 52 to communicate with the wireless tag 50 to receive the stored identification data. The stored identification data is then provided by the wireless communicator 52 back to CPU 41 to complete the authentication operation. In this manner, the electronic device 40 can be authenticated in order to gain secure access to a data network. In other aspects of the present invention, the wireless communicator 52 may also write data onto the wireless tag 50 under the control and direction of CPU 41. Accordingly, the desired identification data may be written onto the wireless tag 50 through instructions received from CPU 41 and executed by wireless communicator 52.

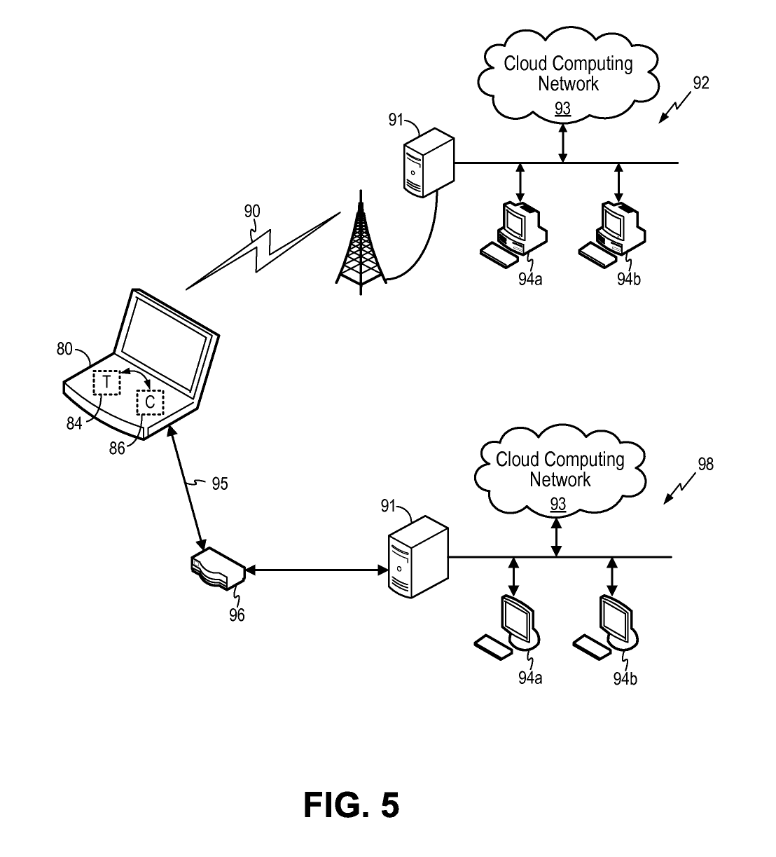

FIG. 5 illustrates a network environment in which the automatic authentication systems and methods of the present invention can be implemented according to one embodiment of the present invention. Referring to FIG. 5, an electronic device 80, which is a laptop computer, has a wireless tag 84 (“T”) and a wireless communicator 86 (“C”) embedded therein. The wireless tag 84 and the wireless communicator 86 can be embedded on the motherboard in the same manner as described above with reference to FIG. 4. As thus configured, the electronic device 80 may then attempt a connection with a data network 92 through a wireless communication link 90. The electronic device 80 may connect to the data network 92 through a server 91. The data network 92 may include interconnected computers 94a and 94b and may also include connection to other networks, such as a cloud computing data network 93. Alternately, the electronic device 80 may then attempt a wired connection with a data network 98 through a wired communication link 95. The electronic device 80 may connect to the data network 98 through a modem 96 which connects to a server 91. The data network 98 may include interconnected computers 94a and 94b and may also include connection to other networks, such as a cloud computing data network 93.

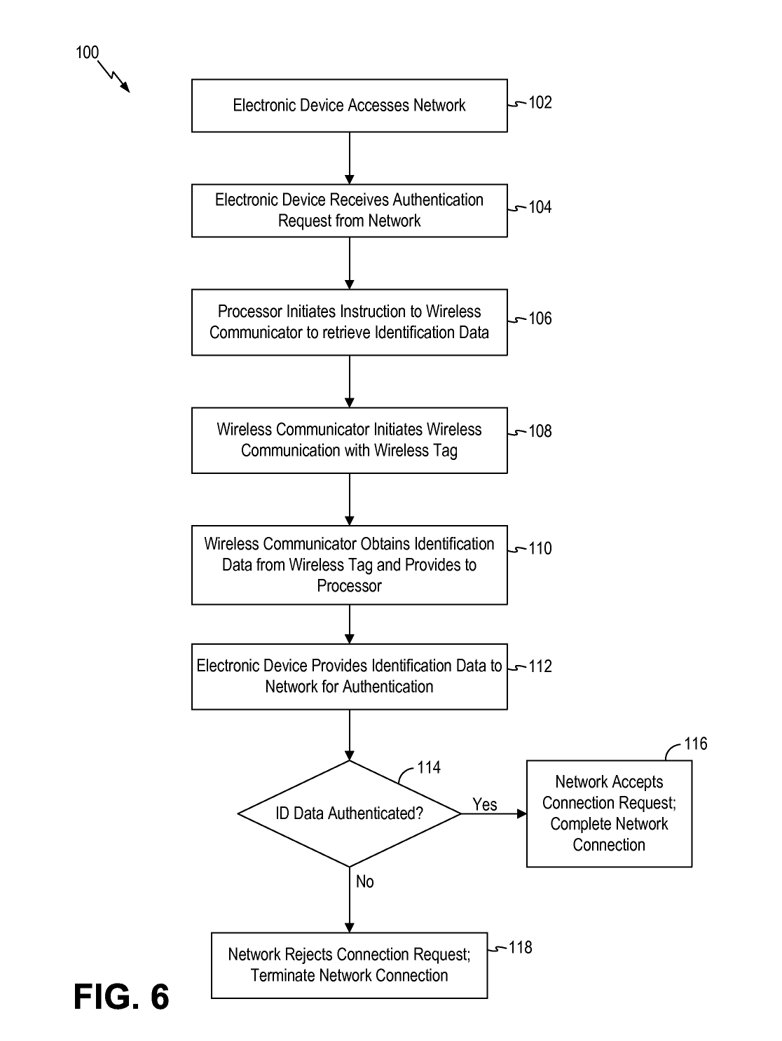

FIG. 6 is a flow chart illustrating an automatic authentication method which can be implemented in the network environment of FIG. 5 according to one embodiment of the present invention. The method of FIG. 6 will be described with reference to the network environment shown in FIG. 5. Referring to FIG. 6, an automatic authentication method 100 starts when an electronic device 80 accesses a data network 92 or 98 (step 102). That is, the electronic device 80 initiates a connection request to the data network. The electronic device 80 receives an authentication request from the data network (step 104). The processor of the electronic device 80, such as the CPU of the motherboard, initiates instruction to the wireless communicator 86 to retrieve identification data stored on the wireless tag 84 (step 106). Accordingly, the wireless communicator 86 initiates wireless communication with the wireless tag 84 (step 108). More specifically, the wireless communicator 86 issues a read command to the wireless tag 84 to instruct the wireless tag to retrieve its stored identification data and transmit the identification data to the wireless communicator 86. The wireless communicator 86 thus obtains the identification data and provides the identification data to the processor, such as the CPU, of the electronic device 80 (step 110).

The electronic device 80 then provides the identification data to the data network for authentication (step 112). The data network may compare the identification data (ID data) to a list of identification numbers of authorized users. Alternately, the data network may compare the identification data to a list of identification numbers of unauthorized users or questionable equipment, such as stolen equipment. An identification data is authenticated either when the ID data is on the list of authorized users or when the ID data is not on the list of unauthorized users. The data network determines whether the identification data provided by the electronic device 80 should be authenticated (step 114). When the identification data passes authentication, the data network accepts the network connection request from the electronic device 80 and the electronic device 80 completes the network connection (step 116). When the identification data fails authentication, the data network rejects the connection request and the electronic device 80 terminates the network connection (step 118). In this manner, the data network allows a connection only when the electronic device attempting the connection is authenticated.

In the above-described embodiment, the electronic device 80 is described as initiating a connection to a data network. It is understood that the automatic authentication method of FIG. 6 can be applied to an electronic device initiating a connection to another electronic device, also referred herein as a “linking electronic device.” The linking electronic device can be a standalone system, such as a computer or a server. In that case, the two electronic devices can be connected to form a data network therebetween. The linking electronic device can also be a communication infrastructure device forming part of a data network. In the present description, the reference to “an electronic device initiating a connection to a data network” includes both of the network scenarios where the linking electronic device is a standalone system and where the linking electronic device is part of a data network.

Embedded Wireless Tag and External Communicator

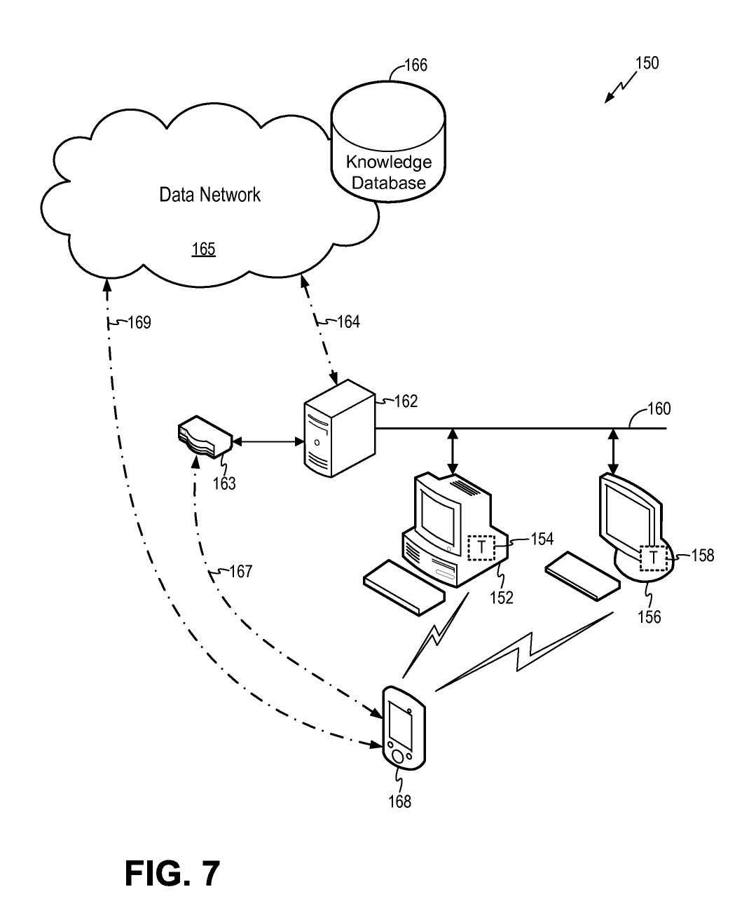

In the above-described embodiments, an electronic device has embedded therein a wireless tag as well as a wireless communicator to communicate with the wireless tag. In alternate embodiments of the present invention, an electronic device has embedded therein only a wireless tag and an external wireless communicator is used to communicate with the embedded wireless tag. FIG. 7 illustrates a network environment in which the automatic authentication systems and methods of the present invention can be implemented according to an alternate embodiment of the present invention.

Referring to FIG. 7, an electronic device 152 has embedded therein a wireless tag 154 (“T”). Another electronic device 156 has embedded therein a wireless tag 158 (“T”). The wireless tags 154 and 158 can be embedded by being incorporated into a semiconductor package of one of the integrated circuits of the electronic devices, as described above with reference to FIG. 4. Electronic devices 152 and 156 are connected to a local area network 160 which includes a server 162 providing connection to a data network 165. Data network 165 may be the publicly accessible Internet. The server 162 may connect to the data network 165 through a two-way communication link, wired or wireless, as denoted by a line 164. In the present description, a dot-dash double arrow line, such as line 164, line 167 and line 169, denotes a two-way communication link which can be wired or wireless.

When the electronic device 152 or 156 wishes to connect to the data network 165, the identity of the electronic device will be authenticated using the automatic authentication method of the present invention. The authentication is carried out with the assistance of an external wireless communicator 168. Wireless communicator 168 is constructed in the same manner as shown in FIG. 3 but as a standalone device. The wireless communicator 168 is placed within close proximity or within the communication range of the wireless tag 154 or 158. The wireless communicator 168 may be in communication with the data network 165 through wired or wireless communication (line 169). Alternately, the wireless communicator 168 may be in communication with a router 163 through a wired or wireless communication (line 167). Through router 163, the wireless communicator 168 may communicate with the data network 165 through server 162.

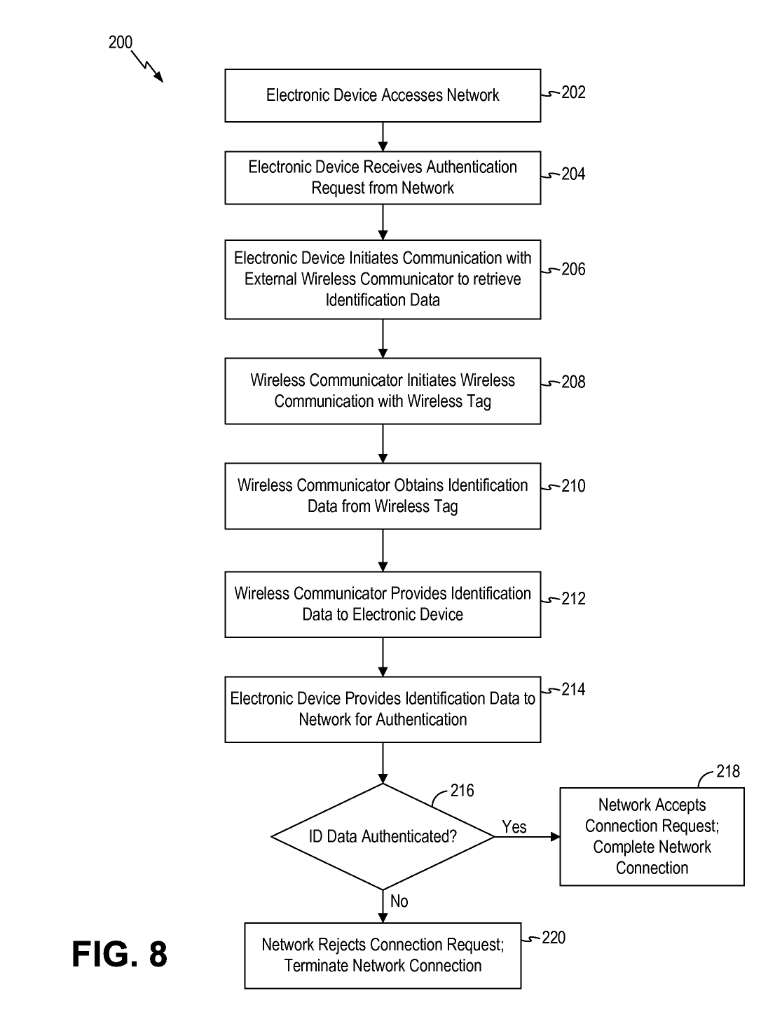

FIG. 8 is a flow chart illustrating an automatic authentication method which can be implemented in the network environment of FIG. 7 according to one embodiment of the present invention. The method of FIG. 8 will be described with reference to the network environment shown in FIG. 7. Referring to FIG. 8, an automatic authentication method 200 starts when an electronic device, such as desktop computer 152, accesses the data network 165 (step 202). That is, the electronic device initiates a connection request to the data network. The electronic device 152 receives an authentication request from the data network 165 (step 204). The electronic device 152 then initiates communication with the external wireless communicator 168 to retrieve the identification data stored on its wireless tag 154 (step 206). The electronic device 152 may communicate with the wireless communicator 168 through a wired connection (such as through router 163) or through a wireless connection (such as when router 163 is a wireless router), as illustrated by link 167. Alternately, the electronic device 152 may communicate with the wireless communicator 168 a previously established network connection through the data network 165, as illustrated by link 169.

When the wireless communicator 168 receives the request instruction from the electronic device 152, the wireless communicator 168 initiates wireless communication with the wireless tag 154 embedded in the electronic device 152 (step 208). More specifically, the wireless communicator 168 issues a read command to the wireless tag 154 to instruct the wireless tag to retrieve its stored identification data and transmit the identification data to the wireless communicator 168. The wireless communicator 168 thus obtains the identification data from the wireless tag (step 210) and provides the identification data to the electronic device 152 (step 212).

The electronic device 152 then provides the identification data to the data network 165 for authentication (step 214). The data network may compare the identification data (ID data) to a list of identification numbers of authorized users. Alternately, the data network may compare the identification data to a list of identification numbers of unauthorized users or questionable equipment, such as stolen equipment. An identification data is authenticated either when the ID data is on the list of authorized users or when the ID data is not on the list of unauthorized users. The data network determines whether the identification data provided by the electronic device 152 should be authenticated (step 216). When the identification data passes authentication, the data network accepts the network connection request from the electronic device 152 and the electronic device 152 completes the network connection (step 218). When the identification data fails authentication, the data network rejects the connection request and the electronic device 152 terminates the network connection (step 220). In this manner, the data network allows a connection only when the electronic device attempting the connection is authenticated.

In the above-described embodiment, the electronic device 152 or 156 is described as initiating a connection to a data network. It is understood that the automatic authentication method of FIG. 8 can be applied to an electronic device initiating a connection to a linking electronic device where the linking electronic device can be a standalone system, such as a computer or a server, or the linking electronic device can be a communication infrastructure device forming part of a data network.

Dual-Port Wireless Tag

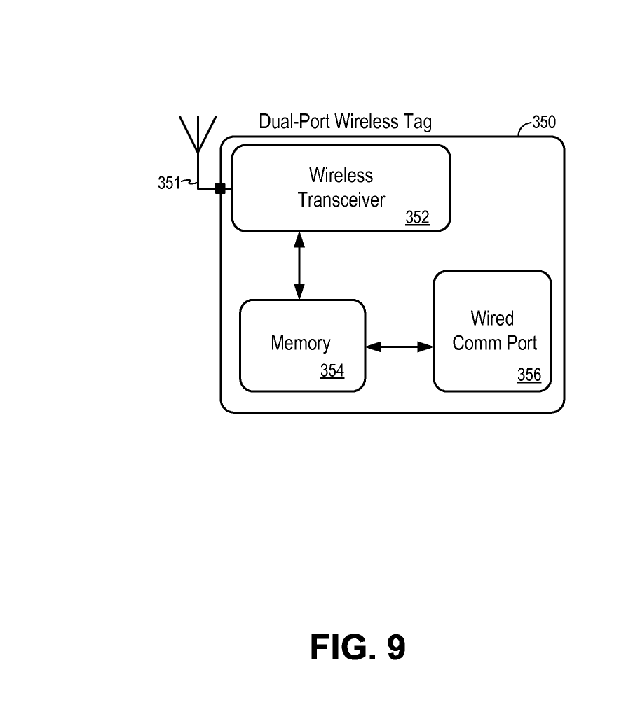

In embodiments of the present invention, the wireless communication device is implemented using a dual-port wireless tag. FIG. 9 is a schematic diagram of a dual-port wireless communication device according to one embodiment of the present invention. Referring to FIG. 9, a dual-port wireless tag 350 includes a wireless transceiver 352, a memory circuit 354 and a wired communication port 356. The wireless transceiver 352 facilitates wireless communication of the wireless tag, such as through radio frequency (RF) communication. The wired communication port 356 facilitates wired communication over a cable or a data bus. In one embodiment, the wired communication port 356 is a wired serial data port. In other embodiments, the wired communication port 356 may be a parallel data bus having the desired data bit width. The wireless transceiver 352 and the wired communication port 356 communicate with the memory circuit 354 over an interface bus. When a dual-port wireless tag is embedded in an electronic device, the identification data stored on the wireless tag may be access through a wired connection formed in the electronic device or through a wireless connection with a wireless communicator.

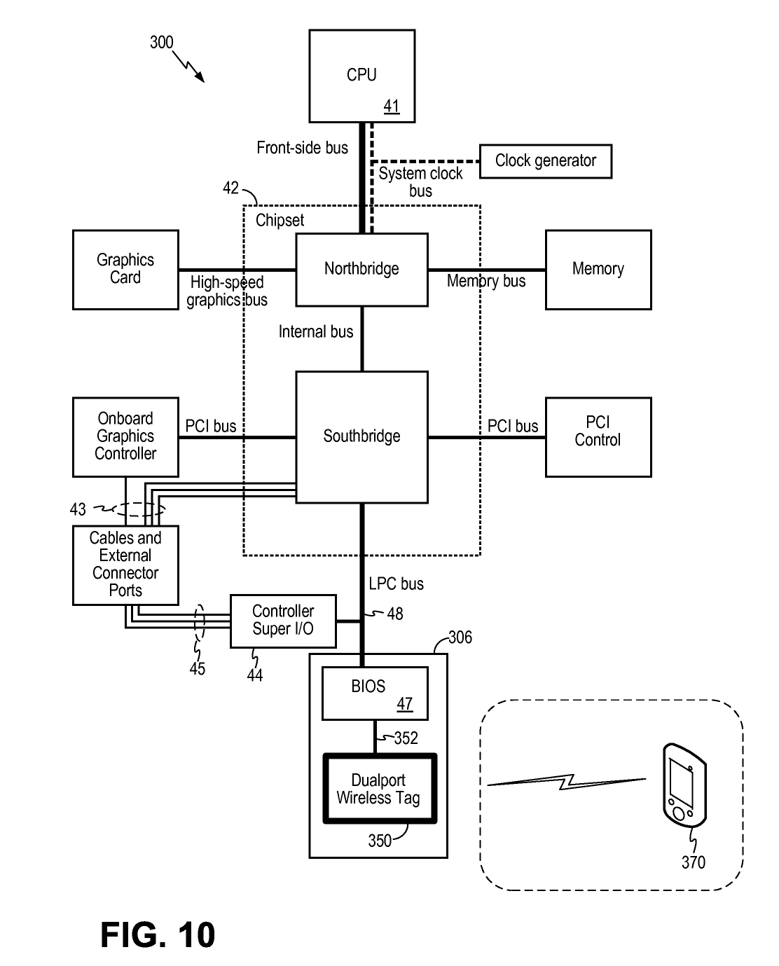

FIG. 10 is a block diagram of an electronic device with a dual-port wireless communication device embedded therein according to one embodiment of the present invention. FIG. 10 illustrates a PC motherboard 300 as the electronic device and the PC motherboard is similar to that one illustrated in FIG. 4 and components of the PC motherboard 300 in FIG. 10 and PC motherboard 40 in FIG. 4 are given like reference numerals and will not be further described. In the embodiment shown in FIG. 10, a dual-port wireless tag 350 is embedded in the same semiconductor package of the basic input/output system (BIOS) semiconductor chip 47. That is, the dual-port wireless tag 350 is formed within the packaging of the BIOS chip 306. Furthermore, the wired communication port of the wireless tag 350 is connected to the BIOS semiconductor chip 47 through a data bus 352. Thus, data stored on the wireless tag 350 may be retrieved by the CPU 41 though the data buses of the PC motherboard, such as the front-side bus and the LPC bus and then through the BIOS semiconductor chip 47. Alternately, the stored data on the wireless tag 350 can be retrieved using an external wireless communicator, such as a wireless communicator 370.

In other embodiments, the dual-port wireless tag can be embedded in other integrated circuits of the electronic device. Embedding the wireless tag in the BIOS chip package 306 is illustrative only.

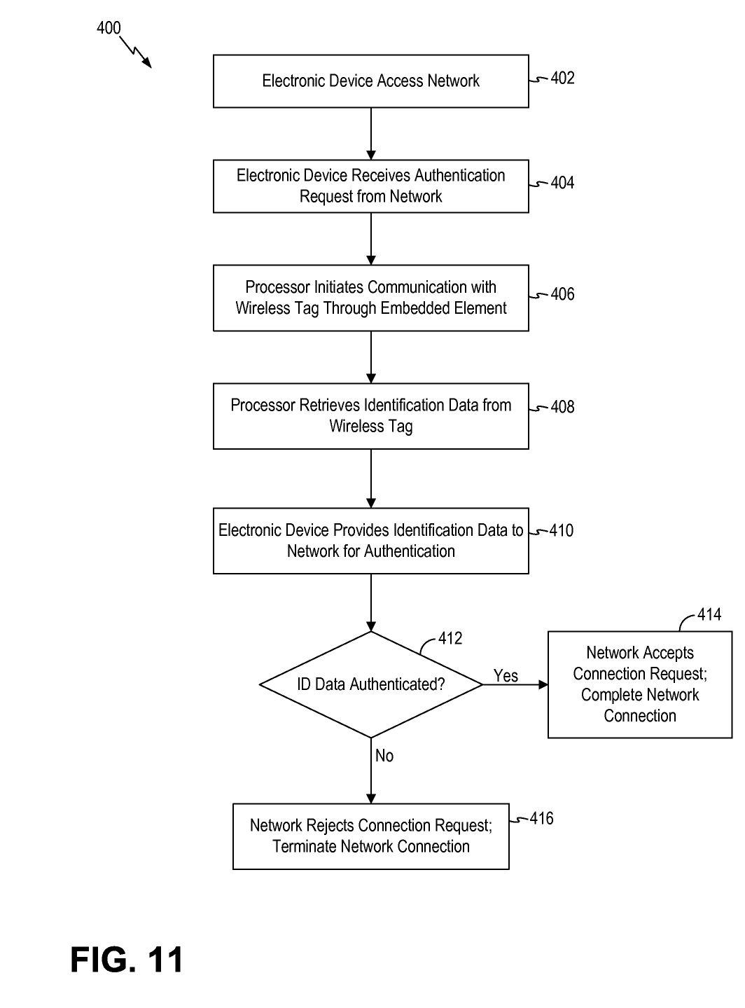

FIG. 11 is a flow chart illustrating an automatic authentication method which can be implemented in the network environment of FIG. 10 according to one embodiment of the present invention. The method of FIG. 11 will be described with reference to the electronic device of FIG. 10. Referring to FIG. 11, an automatic authentication method 400 starts when an electronic device 300 accesses a data network (step 402). That is, the electronic device 300 initiates a connection request to the data network. The electronic device 400 receives an authentication request from the data network (step 404). The processor of the electronic device 300, such as the CPU 41 of the motherboard, initiates instruction to the wireless tag 350 through the embedded element to retrieve identification data stored on the wireless tag (step 406). More specifically, the CPU 41 initiates instruction to the wireless tag 350 through the integrated circuit in which the wireless tag is embedded. In the present embodiment, CPU 41 initiates instructions to the wireless tag 350 through the BIOS semiconductor chip 47. The CPU 41 may issue a read command to the wireless tag 350 to instruct the wireless tag to retrieve its stored identification data and transmit the identification data to the CPU 41. The processor of the electronic device (i.e. CPU 41) thus obtains the identification data from the wireless tag (step 408).

The electronic device 300 then provides the identification data to the data network for authentication (step 410). The data network may compare the identification data (ID data) to a list of identification numbers of authorized users. Alternately, the data network may compare the identification data to a list of identification numbers of unauthorized users or questionable equipment, such as stolen equipment. An identification data is authenticated either when the ID data is on the list of authorized users or when the ID data is not on the list of unauthorized users. The data network determines whether the identification data provided by the electronic device 300 should be authenticated (step 412). When the identification data passes authentication, the data network accepts the network connection request from the electronic device 300 and the electronic device 300 completes the network connection (step 414). When the identification data fails authentication, the data network rejects the connection request and the electronic device 300 terminates the network connection (step 416). In this manner, the data network allows a connection only when the electronic device attempting the connection is authenticated.

In the above-described embodiment, the electronic device 300 is described as initiating a connection to a data network. It is understood that the automatic authentication method of FIG. 11 can be applied to an electronic device initiating a connection to a linking electronic device where the linking electronic device can be a standalone system, such as a computer or a server, or the linking electronic device can be a communication infrastructure device forming part of a data network.

Network Security Method

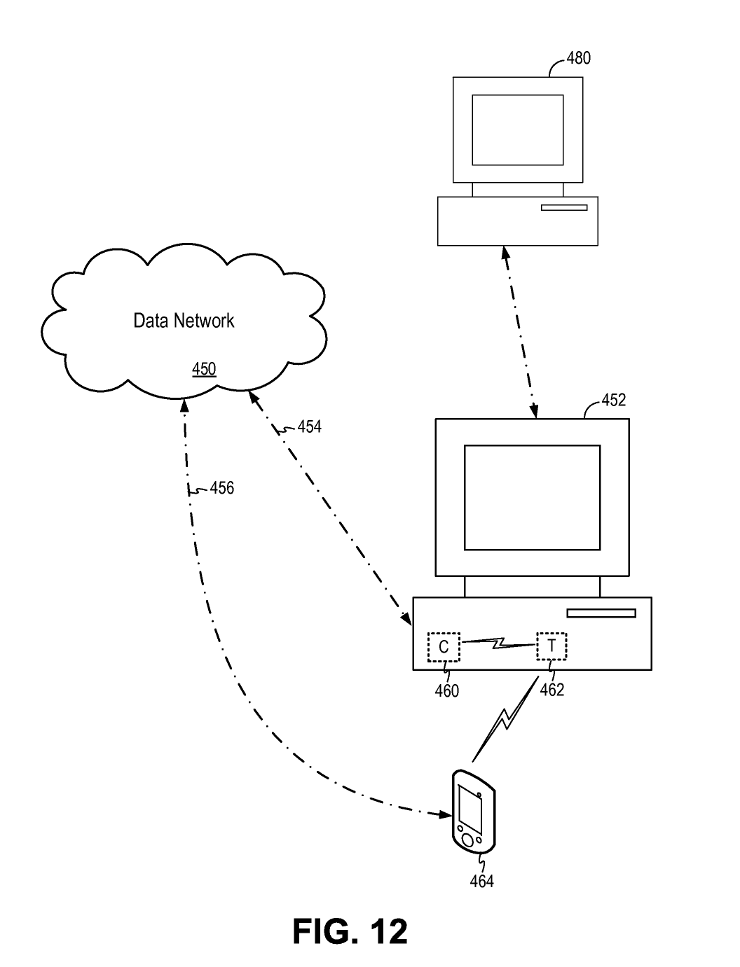

According to another aspect of the present invention, a network security method implements authentication of electronic device as well as protection of misappropriated or suspicious electronic devices. FIG. 12 illustrates a network environment in which the network security method can be implemented according to one embodiment of the present invention. Referring to FIG. 12, an electronic device 452, which is a personal computer in the present illustration, has embedded therein a wireless tag 462. The wireless tag 462 has stored thereon the identification data associated with the electronic device. The electronic device 452 may also have embedded therein a wireless communicator 460 to cooperate with the wireless tag for reading or writing data from and to the wireless tag. In other embodiments, the electronic device 452 may rely on an external wireless communicator 464 to communicate with the wireless tag 462. The embedded wireless communication 460 is optional and may be omitted if an external communicator can be used. The electronic device 452 may be in communication with a data network 450 through a link 454. The external wireless communicator 464 may be in communication with the data network 450 through a link 456. The links 454 and 456 may be wired or wireless communication links.

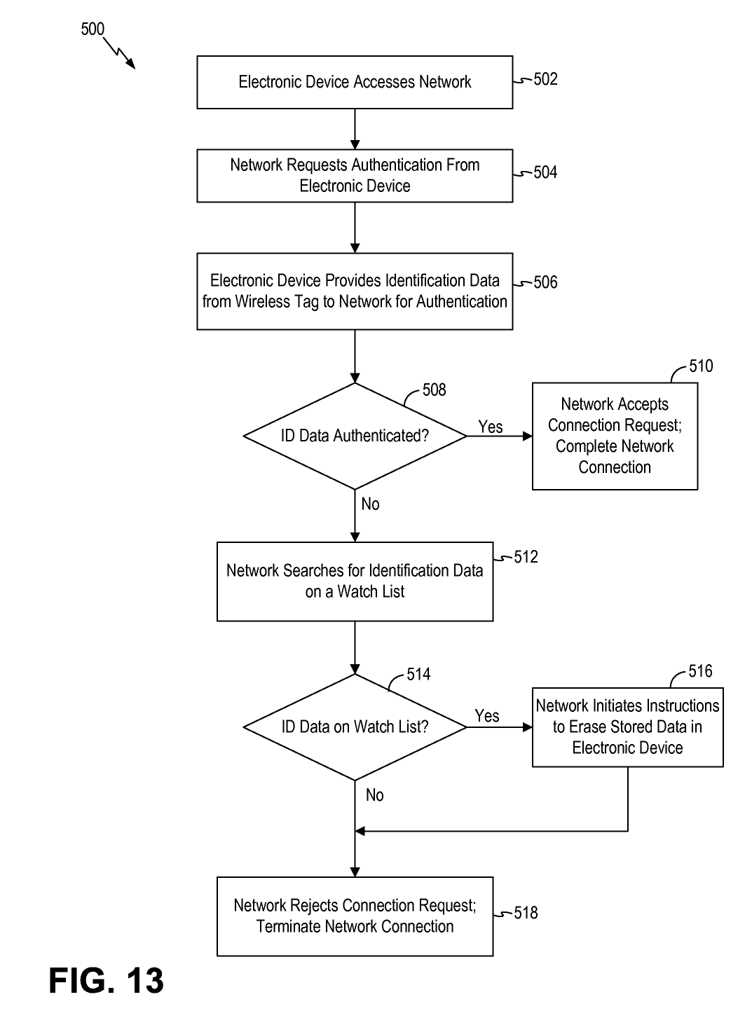

FIG. 13 is a flow chart illustrating a network security method according to one embodiment of the present invention. The operation of the network security method 500 in FIG. 13 will be described with reference to the network environment in FIG. 12. Referring to FIG. 13, the electronic device 452 accesses the data network 450 (step 502). That is, the electronic device 452 initiates a connection request to the data network. The data network 450 requests authentication from the electronic device (step 504). The electronic device 452 then provides the identification data stored on the wireless tag to the data network 450 for authentication (step 506). The electronic device 452 may retrieve the identification data from the wireless tag 462 using any of the methods descried above. For instance, when the electronic device 452 includes an embedded wireless communicator 460, the electronic device 452 may instruct the wireless communicator 460 to communicate with the wireless tag 462 to retrieve the stored identification data. Alternately, the electronic device 452 may communicate with an external communicator 464 and relies on the external communicator 464 to retrieve the stored identification data from the wireless tag 462.

The electronic device 452 provides the identification data to the data network for authentication (step 506). The data network may compare the identification data (ID data) to a list of identification numbers of authorized users. Alternately, the data network may compare the identification data to a list of identification numbers of unauthorized users or questionable equipment, such as stolen equipment. An identification data is authenticated either when the ID data is on the list of authorized users or when the ID data is not on the list of unauthorized users. The data network determines whether the identification data provided by the electronic device 452 should be authenticated (step 508). When the identification data passes authentication, the data network accepts the network connection request from the electronic device 452 and the electronic device 452 completes the network connection (step 510).

On the other hand, when the identification data fails authentication, the data network 450 searches the identification data on a watch list of ID data (step 512). The watch list may contain identification data of unauthorized or stolen equipment for example. The data network determines whether the identification data provided by the electronic device 452 is on the watch list (step 514). If the ID data is not on the watch list, the data network rejects the connection request and the electronic device 452 terminates the network connection (step 518). However, if the ID data is found to be on the watch list, the data network initiates instructions to erase stored data in the electronic device (step 516). In an alternate embodiment, the data network initiates instructions to quarantine the stored data in the electronic device

Then, the data network rejects the connection request and the electronic device 452 terminates the network connection (step 518). In this manner, when a stolen or misappropriated electronic device that is on a watch list attempts to connect to a data network, the data network would cause the stored data on the electronic device to be erased to protect the security of the electronic device. In an alternate embodiment, the data network may issue instructions to impair the electronic device. The network security method of the present invention may have the beneficial effect of discouraging theft of electronic devices.

In the above-described embodiment, the electronic device 452 is described as initiating a connection to a data network. It is understood that the automatic authentication method of FIG. 13 can be applied to an electronic device initiating a connection to a linking electronic device, such as electronic device 480 in FIG. 13, where the linking electronic device can be a standalone system, such as a computer or a server, or the linking electronic device can be a communication infrastructure device forming part of a data network.

Peripheral Device Security Method

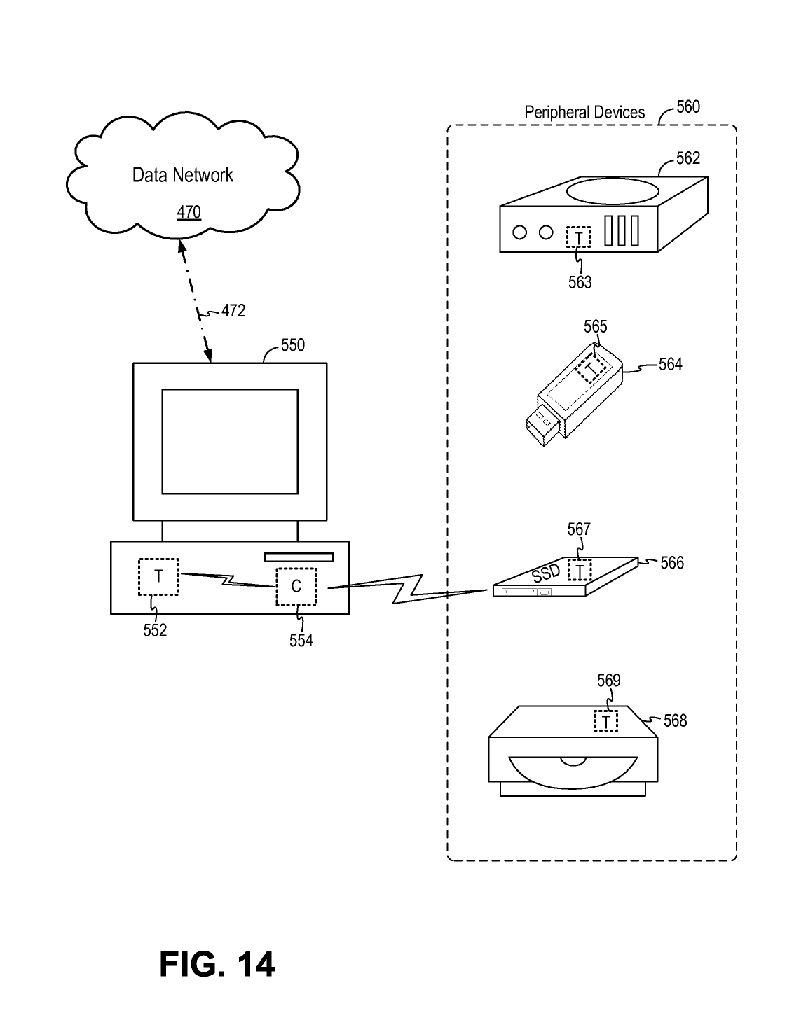

According to another aspect of the present invention, a peripheral device security method implements authentication of peripheral devices that may be connected to an electronic device. FIG. 14 illustrates a computing environment in which the peripheral device security method can be implemented according to one embodiment of the present invention. Referring to FIG. 14, an electronic device 550, which is a personal computer in the present illustration, has embedded therein a wireless tag 552 and a wireless communicator 554. The wireless tag 552 has stored thereon the identification data associated with the electronic device 550. In alternate embodiments, the embedded wireless communicator 554 may be omitted and an external wireless communicator (not shown) may be used. The electronic device 550 may be in communication with a data network 470 through a link 472.

The electronic device 550 may be connected to one or more peripheral devices 560. In the present embodiment, the peripheral devices include an external hard disk drive 562, a universal serial bus (USB) drive 564, a solid-state storage drive (SSD) 566 and a CD or DVD drive 568. The peripheral devices shown in FIG. 14 are illustrative only. Many other types of peripheral devices may be connected to the electronic device 550. When a peripheral device is connected to the electronic device 550, the electronic device 550 may need to authenticate the peripheral device to ensure that the electronic device is not being accessed by an intrusive or unauthorized peripheral device. In accordance with embodiments of the present invention, each of the peripheral devices 560 may be embedded with a wireless tag (“T”), such as wireless tag 563 in hard disk drive 562.

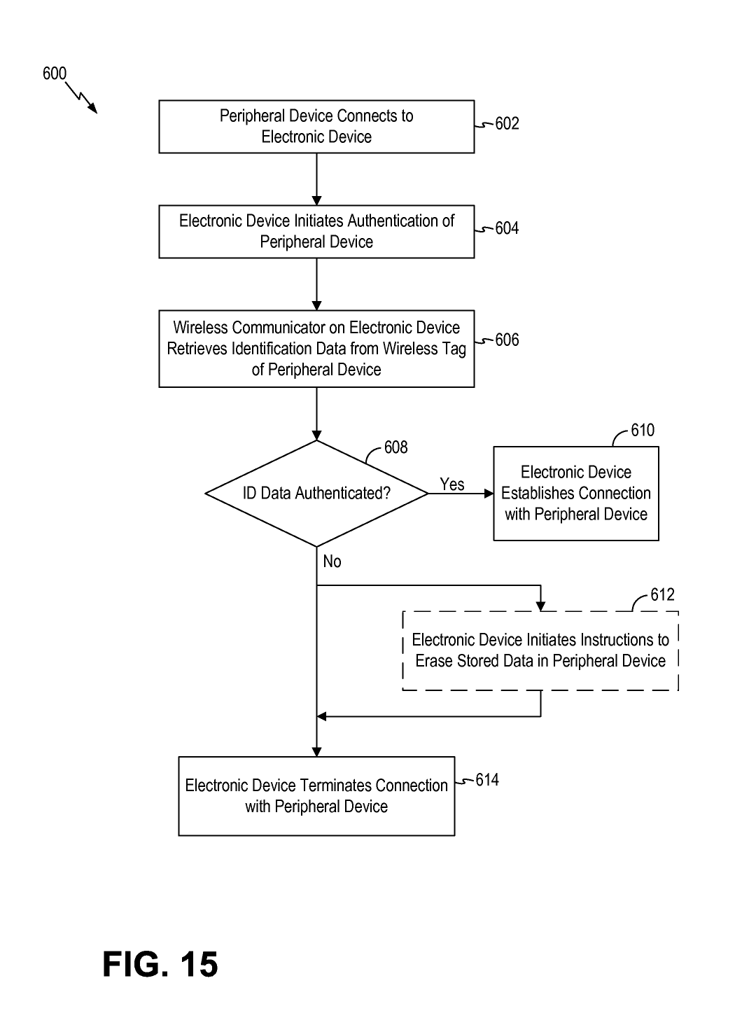

FIG. 15 is a flow chart illustrating a peripheral device security method according to one embodiment of the present invention. The operation of the peripheral device security method 600 in FIG. 15 will be described with reference to the environment in FIG. 14. Referring to FIG. 15, a peripheral device 560 is being connected to the electronic device 550 and initiates a connection request (step 602). The electronic device 550 initiates authentication of the peripheral device 560 (step 604). The wireless communicator 554 of the electronic device 550 initiates communication with the wireless tag embedded in the peripheral device 560. For example, when USB drive 564 is connected to the electronic device 550, the wireless communicator 554 communicates with the wireless tag 565 of the USB drive 564. The wireless communicator 554 retrieves the stored identification data from the wireless tag of the peripheral device (step 606).

The electronic device 550 then authenticates the identification data of the peripheral device. The electronic device 550 may compare the identification data (ID data) of the peripheral device to a list of identification numbers of authorized users. Alternately, the data network may compare the identification data to a list of identification numbers of unauthorized users or questionable equipment, such as stolen equipment. An identification data is authenticated either when the ID data is on the list of authorized users or when the ID data is not on the list of unauthorized users. The electronic device 550 determines whether the identification data provided by the peripheral device 560 should be authenticated (step 608). When the identification data passes authentication, the electronic device 550 accepts the connection request from the peripheral device 560 and the electronic device 550 completes the connection with the peripheral device (step 610).

On the other hand, when the identification data fails authentication, the electronic device 550 terminates the connection with the peripheral device 560 (step 614). In an alternate embodiment, the electronic device 550 may initiates instructions to erase stored data in the peripheral device (step 612) before terminating the connection with the peripheral device 560 (step 614).

In this manner, when an unauthorized or unwelcomed equipment attempts to connect to an electronic device, the electronic device performs authentication to determine if the connection should be allowed and if not, the electronic device may cause the stored data on the peripheral device to be erased to protect the security of the electronic device. In an alternate embodiment, the electronic device may issue instructions to impair the peripheral device. The peripheral device security method of the present invention may have the beneficial effect of discouraging theft of electronic devices.

Electronic Devices Two-Way Authentication

In the above-described embodiments, an electronic device (the “originating electronic device”) initiates a connection to a data network or another electronic device (the “linking electronic device”). The data network or the linking electronic device to which an electronic device requests connection will be referred to herein collectively as “a linking partner.” When the electronic device requests a network connection, the linking partner requests authentication from the originating electronic device. The automatic authentication methods described above can be applied to implement the authentication process. In other embodiments of the present invention, the originating electronic device may itself request authentication from the data network or from the linking electronic device before allowing the connection to complete. In this manner, the originating electronic device ensures that it is indeed being connected to the desired data network or the desired linking electronic device, and not a scam data network or a scam linking electronic device. The authentication of the data network or the linking electronic device assumes that the data network or the linking electronic device have embedded therein a wireless communication device storing identification data and also the data network or the linking electronic device have associated with it a wireless communicator to retrieve the stored identification.

In embodiments of the present invention, the originating electronic device may initiate a connection request with a linking electronic device or with a data network. The originating electronic device may then request authentication from the data network or the linking electronic device. The data network, as embodied by a server, or the linking electronic device will then implement the automatic authentication methods described above to retrieve the identification data stored in the wireless tag embedded with the server or the linking electronic device. The data network server or the linking electronic device provides the retrieved identification data to the originating electronic device for authentication. The originating electronic device may then complete the connection when the identification data of the data network server or the linking electronic device is authenticated. Alternately, the originating electronic device may reject the connection when the identification data of the data network server or the linking electronic device is not authenticated.

More generally, the automatic authentication methods described above can be applied regardless of whether the electronic device is originator of a connection request or the recipient of a connection request. An electronic device, whether an originator or a recipient of a connection request, may receive an authentication request from the linking party and the electronic device may then proceed with retrieving its identification data from the wireless tag embedded in the electronic device and providing the retrieved identification data for authentication. The electronic device may rely on an embedded wireless communicator or an external wireless communication to retrieve the stored identification data from its wireless tag.

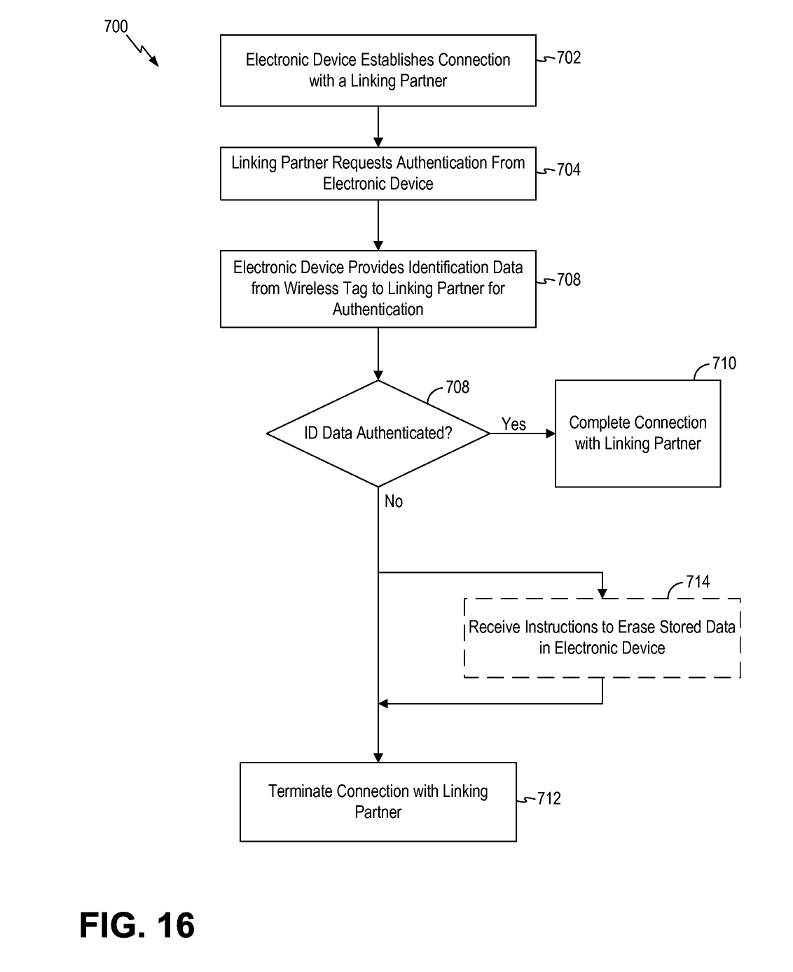

FIG. 16 is a flow chart of an automatic authentication method according to an alternate embodiment of the present invention. The operation of the automatic authentication method 700 in FIG. 16 will be described with reference to the network environment in FIG. 12. Referring to FIG. 16, a first electronic device 452 establishes a connection with a linking partner which may be a second electronic device 480 or a data communication network 450 (step 702). The first electronic device 452 may be the originator of the connection request or the recipient of the connection request. The linking partner (electronic device 480 or data network 450) requests authentication from the first electronic device 452 (step 704). The first electronic device 452 provides the identification data stored on an embedded wireless tag 462 to the linking partner 450, 480 for authentication (step 706). The first electronic device 452 may retrieve the identification data from the wireless tag 462 using any of the methods descried above. For instance, when the first electronic device 452 includes an embedded wireless communicator 460, the first electronic device 452 may instruct the embedded wireless communicator to communicate with the wireless tag to retrieve the stored identification data. Alternately, the first electronic device 452 may communicate with an external communicator 464 and relies on the external communicator to retrieve the stored identification data from the wireless tag.

The electronic device 452 then provides the identification data to the linking partner for authentication (step 706). The linking partner may compare the identification data (ID data) to a list of identification numbers of authorized users. Alternately, the linking partner may compare the identification data to a list of identification numbers of unauthorized users or questionable equipment, such as stolen equipment. An identification data is authenticated either when the ID data is on the list of authorized users or when the ID data is not on the list of unauthorized users. The linking partner determines whether the identification data provided by the electronic device 452 should be authenticated (step 708). When the identification data passes authentication, the linking partner accepts the connection request from the first electronic device 452 and the first electronic device 452 completes the connection (step 710). On the other hand, when the identification data fails authentication, the linking partner rejects the connection request and the first electronic device 452 terminates the network connection (step 712).

In an alternate embodiment, when authentication fails, the linking partner may further initiate instructions to cause the stored data on the electronic device to be erased or otherwise to impair the electronic device (step 714). In this manner, when a stolen or misappropriated electronic device that is on a watch list attempts to connect to a data network or to another electronic device, the linking partner would cause the stored data on the electronic device to be erased to protect the security of the electronic device. The data erasure or device impairment step is optional and may be omitted in other embodiments of the present invention.

Wireless Tag Embedding Method

In the above-described embodiments, the wireless tag is described as being embedded in a semiconductor package of an integrated circuit. In other embodiments of the present invention, the wireless tag can be affixed to the semiconductor package and encapsulated so that the semiconductor package and the wireless tag form a monolithic unit. Embedding a wireless tag by affixing the wireless tag to a semiconductor package allows existing equipment to be retrofitted with the wireless tag so as to implement the automatic authentication methods, the network security methods and the peripheral device security methods (collectively referred to as “authentication methods”) of the present invention.

In the present description, “embedding” a wireless tag with an integrated circuit refers to embedding the wireless tag in the semiconductor package or affixing the wireless tag on the semiconductor package of the integrated circuit. On the other hand, embedding a wireless communicator in an electronic device refers to forming the wireless communicator inside the electronic device which may be inside the housing of the electronic device. The wireless communicator may be embedded by being formed on a printed circuit board of the electronic device.

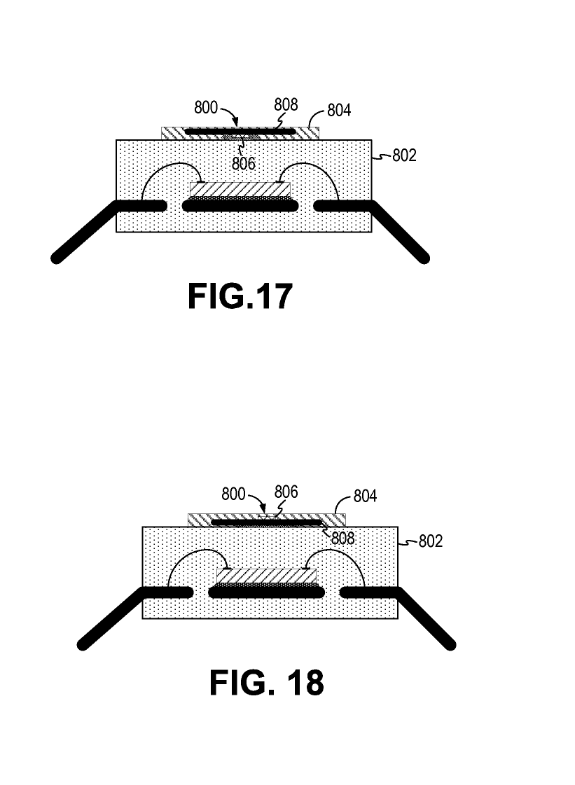

FIG. 17 and FIG. 18 illustrate the gloptop encapsulation methods for affixing a wireless tag to a semiconductor package according to embodiments of the present invention. Referring to FIGS. 17 and 18, a wireless tag 800 is affixed to the top surface of a semiconductor package 802 using a globtop encapsulation method. The wireless tag 800 is preferably formed to have a thin profile. In some embodiments, the wireless tag 800 is flexible or bendable. The wireless tag 800 is attached to the top surface of the semiconductor package 802 which can be a plastic molded package, a lidded cavity package, or a plastic substrate carrier. The wireless tag 800 can be attached in a wireless-chip-down orientation, as shown in FIG. 17 or in a wireless-chip-up orientation, as shown in FIG. 18. More specifically, the wireless tag 800 typically includes a wireless chip 806 formed on a supporting substrate 808. The wireless tag 800 can be attached to the surface of the semiconductor package with the wireless chip facing down so that the wireless chip attaches to the semiconductor package surface, as shown in FIG. 17. Alternately, the wireless tag 800 can be attached to the surface of the semiconductor package with the wireless chip facing up so that the supporting substrate attaches to the semiconductor package surface, as shown in FIG. 18.

The wireless tag 800 thus attached is then encapsulated by a polymer encapsulation layer 804. The polymer encapsulation layer can be formed using a globtop polymer, epoxy or other appropriate plastic encapsulants. In some embodiments, the polymer encapsulation layer has a thickness suitable to encapsulate and bind the wireless tag to the semiconductor package. In one embodiment, the polymer encapsulation layer is of a type that is suitable to be applied to integrated circuits formed on a printed circuit board without causing damage to the printed circuit board.

The above detailed descriptions are provided to illustrate specific embodiments of the present invention and are not intended to be limiting. Numerous modifications and variations within the scope of the present invention are possible. The present invention is defined by the appended claims.

I claim:

1. A method in an electronic device to authenticate the electronic device upon connection to a linking partner, the electronic device comprising one or more integrated circuits, at least one of the one or more integrated circuits being a first processor, the method comprising:
embedding a wireless communication device with one of the one or more integrated circuits, the wireless communication device comprising a first antenna, a first wireless transceiver and a memory circuit having at least identification data stored thereon, the first wireless transceiver and the first antenna operating in conjunction to enable the information stored in the memory circuit to be accessed through wireless communication;
receiving an authentication request from the linking partner;
initiating communication with a wireless communicator, the wireless communicator comprising a second antenna, a second wireless transceiver and a second processor, the second wireless transceiver and the second antenna operating in response to instructions from the second processor to establish wireless communication with the wireless communication device to retrieve stored identification data;
receiving retrieved identification data from the wireless communicator;
transmitting the retrieved identification data to the linking partner for authentication;
when the retrieved identification data is authenticated, establishing connection with the linking partner; and
when the retrieved identification data is not authenticated, terminating connection with the linking partner.

2. The method of claim 1, further comprising:
initiating a connection request to the linking partner prior to receiving an authentication request.

3. The method of claim 1, further comprising:
receiving a connection request from the linking partner prior to receiving an authentication request.

4. The method of claim 1, wherein embedding a wireless communication device with one of the one or more integrated circuits comprises:
embedding the wireless communication device in a semiconductor package of one of the one or more integrated circuits.

5. The method of claim 1, wherein embedding a wireless communication device with one of the one or more integrated circuits comprises:
affixing the wireless communication device on a surface of a semiconductor package of one of the one or more integrated circuits; and
encapsulating the wireless communication device with an encapsulant layer.

6. The method of claim 1, wherein initiating communication with a wireless communicator comprises:
initiating communication with a wireless communicator embedded in the electronic device.

7. The method of claim 1, wherein initiating communication with a wireless communicator comprises:
initiating communication with a wireless communicator external to the electronic device.

8. The method of claim 1, wherein when the retrieved identification data is not authenticated and prior to terminating connection with the linking partner, the method further comprises:
receiving instructions from the linking partner to erase stored data in the electronic device.

9. The method of claim 1, wherein the wireless communication device comprises a radio frequency identification (RFID) tag.

10. The method of claim 1, wherein the linking partner comprises an electronic device or a data communication network.

11. An electronic device including one or more integrated circuits, at least one of the one or more integrated circuits being a first processor, the electronic device comprising:
a wireless communication device embedded with one of the one or more integrated circuits, the wireless communication device comprising a first antenna, a first wireless transceiver and a memory circuit having at least identification data stored thereon, the first wireless transceiver and the first antenna operating in conjunction to enable the information stored in the memory circuit to be accessed through wireless communication; and
a wireless communicator formed embedded in the electronic device, the wireless communicator comprising a second antenna, a second wireless transceiver and a second processor, the second wireless transceiver and the second antenna operating in response to instructions from the second processor to establish wireless communication with the wireless communication device to retrieve stored identification data,
wherein the wireless communicator operates in response to the first processor of the electronic device to retrieve stored identification data from the wireless communication device and to provide the retrieved identification data to the first processor.

12. The electronic device of claim 11, wherein the wireless communication device comprises a radio frequency identification (RFID) tag.

13. The electronic device of claim 11, wherein the electronic device comprises one of a server, a router, a desktop computer, a laptop computer, a hand held computer, a netbook computer, an tablet computer, a smartphone, a mobile computing equipment, an eBook reader, a video game console, and a telecommunication equipment.

14. The electronic device of claim 11, wherein the wireless communication device is embedded in a semiconductor package of the one of the one or more integrated circuits.

15. The electronic device of claim 11, wherein the wireless communication device is affixed to a surface of a semiconductor package of the one of the one or more integrated circuits, the wireless communication device being encapsulated by an encapsulant layer.

16. An electronic device including one or more integrated circuits, at least one of the one or more integrated circuits being a first processor, the electronic device comprising:
a dual-port wireless communication device embedded with one of the one or more integrated circuits, the wireless communication device comprising a first antenna, a first wireless transceiver, a memory circuit having at least identification data stored thereon, and a wired communication port, the first wireless transceiver and the first antenna operating in conjunction to enable the information stored in the memory circuit to be accessed through wireless communication, the wired communication port operating to enable the information stored in the memory circuit to be accessed through wired communication,
wherein the first processor initiates instructions to the dual-port wireless communication device through the wired communication port to retrieve stored identification data from the wireless communication device and to provide the retrieved identification data to the first processor.

17. The electronic device of claim 16, wherein the wireless communication device comprises a dual-port radio frequency identification (RFID) tag.

18. The electronic device of claim 16, wherein the electronic device comprises one of a server, a router, a desktop computer, a laptop computer, a hand held computer, a netbook computer, an tablet computer, a smartphone, a mobile computing equipment, an eBook reader, a video game console, and a telecommunication equipment.

19. The electronic device of claim 16, wherein the dual-port wireless communication device is embedded in a semiconductor package of the one of the one or more integrated circuits.

20. A method in an electronic device to authenticate the electronic device upon connection to a linking partner, the electronic device comprising one or more integrated circuits, at least one of the one or more integrated circuits being a first processor, the method comprising:
embedding a dual-port wireless communication device with one of the one or more integrated circuits, the wireless communication device comprising a first antenna, a first wireless transceiver, a memory circuit having at least identification data stored thereon, and a wired communication port, the first wireless transceiver and the first antenna operating in conjunction to enable the information stored in the memory circuit to be accessed through wireless communication, the wired communication port operating to enable the information stored in the memory circuit to be accessed through wired communication;
receiving an authentication request from the linking partner;
initiating communication with the wireless communication device through the wired communication port;
retrieving stored identification data from the wireless communication device;
transmitting the retrieved identification data to the linking partner for authentication;
when the retrieved identification data is authenticated, establishing connection with the linking partner; and
when the retrieved identification data is not authenticated, terminating connection with the linking partner.

21. The method of claim 20, wherein the wireless communication device comprises a radio frequency identification (RFID) tag.

22. The method of claim 1, wherein embedding a dual-port wireless communication device with one of the one or more integrated circuits comprises:
embedding a dual-port wireless communication device in a semiconductor package of one of the one or more integrated circuits.

23. A method in an electronic device to authenticate a peripheral device upon connection to the electronic device, the peripheral device comprising one or more integrated circuits, the peripheral device having a wireless communication device embedded with one of the one or more integrated circuits of the peripheral device, the wireless communication device comprising a first antenna, a first wireless transceiver and a memory circuit having at least identification data stored thereon, the first wireless transceiver and the first antenna operating in conjunction to enable the information stored in the memory circuit to be accessed through wireless communication, the method comprising:
receiving a connection request from the peripheral device;
initiating authentication of the peripheral device;
initiating communication with a wireless communicator, the wireless communicator comprising a second antenna, a second wireless transceiver and a second processor, the second wireless transceiver and the second antenna operating in response to instructions from the processor to establish wireless communication with the wireless communication device embedded in the peripheral device to retrieve stored identification data;
receiving retrieved identification data from the wireless communicator;
authenticating the retrieved identification data is authentic;
when the retrieved identification data is authenticated, establishing connection with the peripheral device; and
when the retrieved identification data is not authenticated, terminating connection with the peripheral device.

24. The method of claim 23, wherein when the retrieved identification data is not authenticated and prior to terminating connection with the peripheral device, the method further comprises transmitting instruction to the peripheral device to erase stored data in the peripheral device.

25. The method of claim 23, wherein initiating communication with a wireless communicator comprises:
initiating communication with a wireless communicator embedded in the electronic device.

26. The method of claim 23, wherein initiating communication with a wireless communicator comprises:
initiating communication with a wireless communicator external to the electronic device.

27. The method of claim 23, wherein the wireless communication device comprises a radio frequency identification (RFID) tag.
